(19) United States
(12) Patent Application Publication
(10) Pub. No.: US 2013/0229092 A1
(43) Pub. Date: Sep. 5, 2013

(54) ELECTRICITY GENERATING AXLE AND ELECTRICITY GENERATING HUB FOR A VEHICLE

(71) Applicant: Thomas GRADY, McLean, VA (US)

(72) Inventor: Thomas GRADY, McLean, VA (US)

(21) Appl. No.: 13/856,782

(22) Filed: Apr. 4, 2013

Related U.S. Application Data
(63) Continuation-in-part of application No. 12/925,016, filed on Aug. 23, 2011.
(60) Provisional application No. 61/278,844, filed on Oct. 14, 2009.

(51) Int. Cl. H02K 7/14

(52) U.S. Cl. CPC H02K 7/14
USPC 310/67 R

(57) ABSTRACT

A generating axle for a vehicle. The generating axle can include a hollow, tubular housing, a shaft rotatably disposed within the housing, at least one armature carried by the shaft, and at least one permanent magnet carried by the housing, wherein the at least one armature and the at least one permanent magnet are disposed such that a current is induced in the armature when the shaft is rotated with respect to the housing.

### CROSS-REFERENCE TO RELATED APPLICATIONS

This application is a continuation-in-part of U.S. patent application Ser. No. 12/925,016, filed Aug. 23, 2011, and entitled Generating Axle, which is the non-provisional of U.S. Provisional Patent Application 61/278,844, filed Oct. 14, 2009, the entire contents of which are hereby incorporated by reference in their entirety.

### BACKGROUND

The increasing cost of fossil fuels as well as environmental concerns have spurred a movement towards energy efficiency as well as energy recovery in vehicles. Hybrid vehicles combining internal combustion engines and electric motors, as well as purely electric vehicles are gaining an increasing share of the market. Many such vehicles also employ energy recovery technologies. One example of such a technology is regenerative braking, whereby the vehicle's kinetic energy is converted into electrical energy instead of being given off as heat as a result of friction braking.

### SUMMARY

According to at least one exemplary embodiment, a generating axle for a vehicle is disclosed. The generating axle can include a hollow, tubular housing, a shaft rotatably disposed within the housing, at least one armature carried by the shaft, and at least one permanent magnet carried by the housing, wherein the at least one armature and the at least one permanent magnet are disposed such that a current is induced in the armature when the shaft is rotated with respect to the housing.

According to another exemplary embodiment, a generating wheel hub for a vehicle is disclosed. The generating wheel hub can include a hollow, tubular housing, a shaft rotatably disposed within the housing, at least one armature carried by the shaft, and at least one permanent magnet carried by the housing, wherein the at least one armature and the at least one permanent magnet are disposed such that a current is induced in the armature when the housing is rotated with respect to the shaft.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 is an exemplary diagram of a vehicle having generating axles.

FIGS. 2a-2d are diagrams of exemplary layouts of vehicles having generating axles.

FIG. 3 is a longitudinal section view of an exemplary embodiment of a generating axle.

FIGS. 4a-4b are cross section views of exemplary embodiments of generating axles.

FIG. 5 is a longitudinal section view of an exemplary embodiment of a generating wheel hub.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

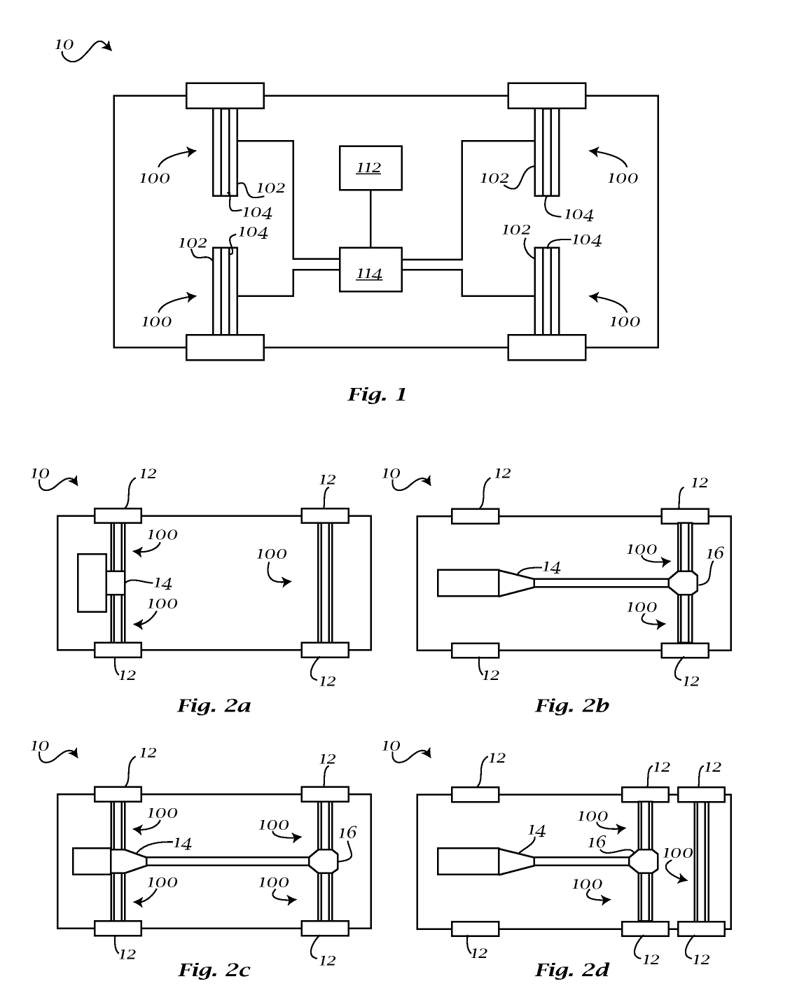

Generally referring to FIGS. 1-4b and according to at least one exemplary embodiment, a generating axle 100 for a vehicle 10 is disclosed. The generating axle 100 can include a tubular outer housing 102 and a shaft 104 rotatably disposed within the housing. The shaft 104 can carry an armature 106, while the housing 102 can carry a plurality of permanent magnets 108.

In some exemplary embodiments, a plurality of generating axles 100 may be provided on a vehicle 10. In some exemplary embodiments, the generating axles 100 may be provided in lieu of conventional axle half-shafts that are coupled to the wheels 12 of the vehicle, and the shafts 104 of the generating axles 100 may be driven by the vehicle's drivetrain. For example, in vehicles having FF, RR, or RMR layouts, the generating axles 100 may be disposed between the transmission 14 and the drive wheels 12 of the vehicle. In vehicles having FR or similar layouts, the generating axles 100 may be disposed between the rear differential 16 and rear wheels 12 of the vehicle. In four wheel drive or all wheel drive vehicles, the generating axles 100 may be disposed between both the transmission 14 and the front wheels 12 of the vehicle, as well as between the rear differential 16 of the vehicle. In other exemplary embodiments, the generating axles 100 may be provided as non-driving axles of a vehicle, for example in place of any type of dead axle of the vehicle or on a trailer of the vehicle. However, the above examples should not be construed as limiting, and any arrangement that allows the generating axles 100 to function as described herein may be contemplated and provided as desired.

The generating axle 100 may be joined to the other components of the vehicle in any known manner that allows the axles to function as described herein. For example the shafts 104 of the generating axles 100 may be joined to the other components of the vehicle, such as wheels, transmission output shafts, differentials, and so forth by way of CV joints, universal joints, gearing arrangements, or the like. The housing 102 of the generating axle 100 may be joined to any suitable component of the automobile frame, suspension, and so forth, so as to allow housing 102 to remain stationary with respect to the rotation of shaft 104 therein. For example, in a live axle setup, housing 102 of the generating axle 100 may be coupled to the differential housing, or may be provided integrally with the differential housing. In other suspension setups, the housing 102 may be provided in any way that can allow the housing to enclose shaft 104 and for shaft 104 to rotate freely within the housing 102 during operation of the vehicle. It is envisioned that embodiments of the generating axle 100 may be adapted for any desired vehicle suspension arrangement.

An armature 106, formed from a conductive material such as copper, may be carried by the shaft 104 of the generating axle. The armature 106 can include a plurality of windings of the conductive material, which may be provided in any desired number and configuration. The armature 106 can be disposed over a portion of the length of shaft 104, or for substantially the entirety of the length of shaft 104. The windings of armature 106 can be disposed in any arrangement or orientation that induces a current in armature 106 when shaft 104 is rotated with respect to housing 102.

In some exemplary embodiments, armature 106 may be coupled to and may cover the surface of shaft 104. A clearance between armature 106 and the inner surface of housing 102 may be provided so as to allow shaft 104 and armature 106 to rotate freely within housing 102. In other exemplary embodiments, the windings of armature 106 may be disposed within grooves or channels 110 defined in the outer surface of shaft 104 such that armature 106 does not protrude beyond the outer surface of shaft 104. In such embodiments, the clearance between armature 104 and the inner surface of housing 102 may be reduced.

A plurality of permanent magnets 108 may be carried by housing 102. The magnets 108 may be disposed on or proximate the inner surface of housing 102 in at least one location corresponding to the location of armature 106. Both the orientation of magnets 108 as well as the distance of magnets 108 from armature 106 may be selected so as to induce a current in armature 106 when shaft 106 is rotated with respect to housing 104.

Embodiments of generating axle 100 may be adapted as desired to provide direct current or alternating current to the electrical system of the vehicle. The embodiments of generating axle 100 may further be adapted to provide electrical power at any desired voltage. The transmission of generated electrical power from the rotating armature 106 to any static part of the vehicle may be provided in any manner known in the art, including brushes, slip rings, commutators, or any other known structure that enables the generating axle 100 to function as described herein.

The armature 106 of each generating axle 100 may be electrically coupled to the electrical system of the vehicle. In some exemplary embodiments, the armature 106 of each generating axle 100 may be electrically coupled to at least one battery 112. The electricity generated by each generating axle 100 may be stored in the battery 112. If necessary, a rectifier may be provided between generating axle 100 and battery 112 or any other suitable part of the electrical system of the vehicle.

In some exemplary embodiments, the operation of generating axle 100 may be controlled by a control unit 114 of the vehicle. Consequently, the operation of axle 100 may be controlled so as to generate electrical power only in desired situations or in response to desired actions. For example, generating axle 100 may be operable when a reduction of vehicle speed is desired, and can thus perform a regenerative braking function. As another illustrative example, if a vehicle has a plurality of generating axles 100, the operation of each generating axle 100 may be controlled separately based on any desired criteria or conditions.

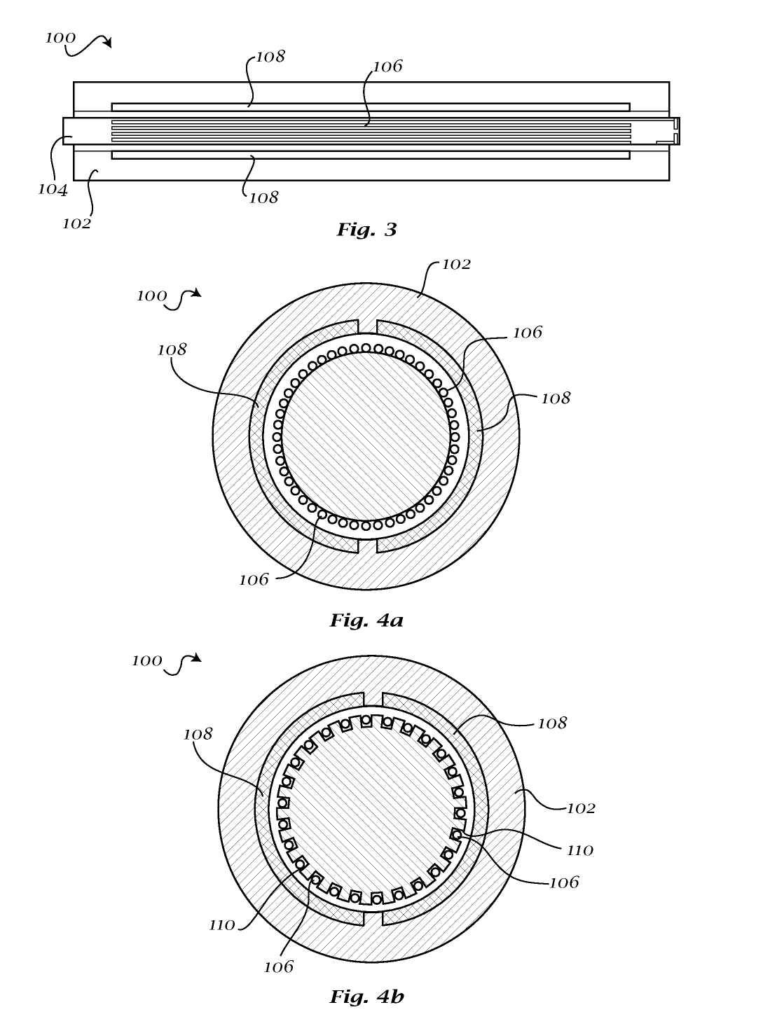

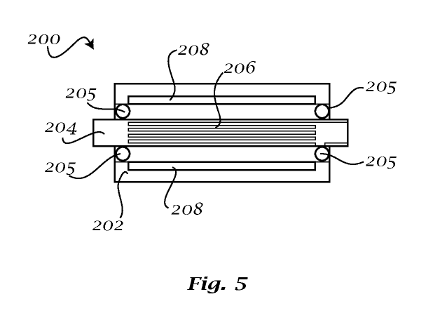

FIG. 3 shows an exemplary embodiment of a generating wheel hub 200. The exemplary embodiment of generating wheel hub 200 may be used on two-wheeled vehicles such as bicycles, mopeds, motorcycles, and the like, or any other vehicle where wheel hubs are used in place of axles. The generating wheel hub 200 may be used in lieu of standard wheel hubs of the vehicle. To that end, the generating wheel hub 200 may include a shaft 204 which may be coupled to the suspension, or any other suitable member of the vehicle, and may be supported within housing 202 by bearings 205. Housing 202, in turn, may be coupled to the wheel of the vehicle. When the vehicle is in operation, the shaft 204 may remain stationary while housing 202 may rotate when the wheel of the vehicle is in motion.

Similarly to the generating axle 100, an armature 206 may be carried by the shaft 204 of the generating hub 200. The armature 206 can include a plurality of windings of the conductive material, which may be provided in any desired number and configuration. The armature 206 can be disposed over a portion of the length of shaft 204, or for substantially the entirety of the length of shaft 204. The windings of armature 206 can be disposed in any arrangement or orientation that induces a current in armature 206 when housing 202 is rotated with respect to shaft 204. Furthermore, similar to the generating axle 100, the armature 206 may be disposed on the surface of shaft 204, or within a groove or channel defined in the outer surface of shaft 204 such that armature 206 does not protrude beyond the outer surface of shaft 204.

A plurality of permanent magnets 208 may be carried by housing 202. The magnets 208 may be disposed on or proximate the inner surface of housing 202 in at least one location corresponding to the location of armature 206. Both the orientation of magnets 208 as well as the distance of magnets 208 from armature 206 may be selected so as to induce a current in armature 206 when housing 204 is rotated with respect to shaft 202.

The embodiments of generating hub 200 may be adapted as desired to provide direct current or alternating current to the electrical system of the vehicle and to provide electrical power in any desired voltage. The armature 206 of each generating hub 200 may be electrically coupled to the electrical system of the vehicle in any manner known in the art. In some exemplary embodiments, the armature 206 of each generating hub 200 may be electrically coupled to at least one battery 212. Furthermore, similar to generating axle 100, the operation of generating hub 200 may be controlled, if desired, by a control unit of the vehicle. Alternatively, on some vehicles such as bicycles, the operation of generating hub 200 may be controlled manually. Consequently, the operation of hub 200 may be controlled so as to generate electrical power only in desired situations or in response to desired actions. For example, generating hub 200 may be operable when a reduction of vehicle speed is desired, and can thus perform a regenerative braking function.

In some exemplary embodiments, the generating axle 100 and generating wheel hub 200 may be provided as a replacement part for vehicles not having regenerative braking or other energy recovery abilities. Embodiments of the generating axle and generating hub disclosed herein may be adapted for various such vehicle models and may be used to replace conventional axles or wheel hubs on such vehicles. The generating axles or wheel hubs may then be electrically coupled to the electrical system of the vehicle, thereby providing additional electrical power, as well as regenerative braking capabilities to the vehicle. An exemplary vehicle on which the generating axles may be used may be trailers or other large cargo vehicles, for example trailers having large power consumption requirements. Use of the generating axle on vehicles such as trailers can provide additional power to the vehicle and can also reduce the wear on the braking components of the vehicle. Exemplary vehicles on which the generating wheel hubs may be used include motorcycles or bicycles, where the additional generated electricity may be used to power accessories such as additional lights, heated elements, and so forth.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A generating axle for a vehicle, comprising:
a hollow, tubular housing;
a shaft rotatably disposed within the housing;
at least one armature carried by the shaft; and
at least one permanent magnet carried by the housing;
wherein the at least one armature and the at least one permanent magnet are disposed such that a current is induced in the armature when the shaft is rotated with respect to the housing.

2. The axle of claim 1, wherein the armature is disposed on the surface of the shaft.

3. The axle of claim 1, wherein the armature is disposed in a channel defined in the surface of the shaft.

4. The axle of claim 1, wherein the axle is electrically coupled to a battery of the vehicle.

5. The axle of claim 1, wherein the shaft is coupled to a differential of the vehicle.

6. The axle of claim 1, wherein the shaft is coupled to a transmission of the vehicle.

7. The axle of claim 1, wherein the vehicle is a passenger vehicle.

8. The axle of claim 1, wherein the vehicle is a trailer.

9. A generating hub for a vehicle, comprising:
a hollow, tubular housing;
a shaft rotatably disposed within the housing;
at least one armature carried by the shaft; and
at least one permanent magnet carried by the housing;
wherein the at least one armature and the at least one permanent magnet are disposed such that a current is induced in the armature when the housing is rotated with respect to the shaft.

10. The axle of claim 9, wherein the armature is disposed on the surface of the shaft.

11. The axle of claim 9, wherein the armature is disposed in a channel defined in the surface of the shaft.

12. The axle of claim 9, wherein the axle is electrically coupled to a battery of the vehicle.

13. The axle of claim 9, wherein the vehicle is a motorcycle.

14. The axle of claim 9, wherein the vehicle is a bicycle.
